(19) United States
(12) Patent Application Publication
(10) Pub. No.: US 2025/0160546 A1
(43) Pub. Date: May 22, 2025

(54) Plant Grow Ring

(71) Applicant: Robert Ghobrial, OVIEDO, FL (US)

(72) Inventor: Robert Ghobrial, OVIEDO, FL (US)

(21) Appl. No.: 18/517,312

(22) Filed: Nov. 22, 2023

(51) Int. Cl. A47G 7/02; A01G 9/12

(52) U.S. Cl. CPC A47G 7/02; A01G 9/12

(57) ABSTRACT

A plant grow ring may include a main body and a cylindrical main body having an inner surface, an exterior surface, a top surface, and a bottom surface. The plant grow ring may include a plurality of legs protruding from the bottom surface of the cylindrical main body, wherein each leg of the plurality of legs comprises a width and a height, and wherein each leg of the plurality of legs is curved across the width to match a curvature of the inner surface of the cylindrical main body. The plant grow ring may further include a plurality of ridges formed on the exterior surface of the cylindrical main body and adjacent to the top surface of the cylindrical main body, wherein at least a top ridge of the plurality of ridges are configured to releasably couple with a corresponding mating feature of one or more accessories.

### FIELD OF TECHNOLOGY

The present disclosure relates generally to planting rings to support plant growth.

### BACKGROUND

Hydrophobic soil occurs when soil particles develop a water-repellent coating, often due to the deposition of waxy substances. These waxy compounds are typically released during events like fires or through the natural decomposition of organic materials, such as certain types of vegetation known for their waxy properties. This phenomenon predominantly affects sandy soils, where the larger grain size allows for more complete coverage by these hydrophobic substances. Factors like soil texture, the presence of organic matter, chemical composition, and regional environmental conditions contribute to the development and severity of soil hydrophobicity. This condition significantly impacts agricultural productivity and environmental health. In hydrophobic soils, water infiltration is severely hindered, leading to various challenges including increased surface runoff, accelerated soil erosion, uneven distribution of moisture and nutrients, and a heightened risk of soil contamination. These effects collectively pose a substantial obstacle to plant growth and sustainability in gardening and farming practices.

### SUMMARY

The systems, methods and devices of this disclosure each have several innovative aspects, no single one of which is solely responsible for the desirable attributes disclosed herein.

The described techniques relate to improved devices, apparatuses, methods, and systems, that support plant growth through the use of a planting apparatus, referred to herein as a plant grow ring. The described planting apparatus supports root growth and development, particularly in hydrophobic soils. For example, the described planting apparatus is configured to direct water and nutrients to plant roots, prevent runoff, deter pests, facilitate pollinator attraction, and optimize overall growth conditions of plants. As described in more detail herein, one or more features of the planting apparatus may serve multiple functions, such as deterring pests and functioning as an attachment point for one or more planting accessories that enhance the functionality of the planting apparatus (e.g., a removable tray for strawberries, a removable greenhouse attachment or topper for seedlings).

A plant grow ring may include a cylindrical main body having an inner surface, an exterior surface, a top surface, and a bottom surface. The plant grow ring may include a plurality of legs protruding from the bottom surface of the cylindrical main body, wherein each leg of the plurality of legs comprises a width and a height, and wherein each leg of the plurality of legs is curved across the width to match a curvature of the inner surface of the cylindrical main body. The plant grow ring may further include a plurality of ridges formed on the exterior surface of the cylindrical main body and adjacent to the top surface of the cylindrical main body, wherein at least a top ridge of the plurality of ridges are configured to releasably couple with a corresponding mating feature of one or more accessories that are attachable to the top surface of the cylindrical main body.

In some examples, the plant grow ring may further include a hole disposed through the cylindrical main body and configured to releasably couple with an irrigation tube. In some examples, the hole is located among the plurality or ridges.

In some examples of the plant grow ring, the one or more accessories may be a tray attachment configured to releasably couple with at least the top ridge of the plurality of ridges by snapping onto the at least top ridge. In some examples, the tray attachment may include an annulus portion having an exterior circumference, an inner circumference, and a plurality of slits formed through a thickness of the annulus portion, wherein a diameter of the inner circumference is less than a diameter of the inner surface of the cylindrical main body, and wherein a diameter of the exterior circumference is greater than a diameter of the exterior surface of the cylindrical main body.

In some examples of the plant grow ring, the one or more accessories may be a greenhouse attachment configured to releasably couple with at least the top ridge of the plurality of ridges by snapping onto the at least top ridge. In some examples, the greenhouse attachment comprises a domed surface made from an at least partially translucent material and a plurality of holes formed through a thickness of the domed surface.

In some examples, the plant grow ring may further include an adhesive layer formed over at least the plurality of ridges.

In some examples, at least the cylindrical main body and the plurality of legs are formed from an ultraviolet stabilized copolymer polypropylene plastic material that is formed via an injection molding process. In some examples, at least the cylindrical main body and the plurality of legs are formed from a biodegradable material.

In some examples, the cylindrical main body may further include a slit running along a full height of the cylindrical main body such that the cylindrical main body is openable, wherein the cylindrical main body further comprises a latching features the secures the cylindrical main body in a closed position.

### BRIEF DESCRIPTION OF THE DRAWINGS

FIG. 1 illustrates an example of a plant grow ring in accordance with aspects of the present disclosure.

FIGS. 2A-2B illustrate an example of a plant grow ring with a tray attachment in accordance with aspects of the present disclosure.

FIGS. 3A-3B illustrate an example of a plant grow ring with a greenhouse attachment in accordance with aspects of the present disclosure.

### DETAILED DESCRIPTION

As described herein, a plant grow ring may be used to support enhanced root growth and plant nourishment by directing water and nutrients to plant roots, preventing runoff, deterring pests, facilitating pollinator attraction, and optimizing overall growth conditions of plants. A plant grow ring may include a main body portion that generally comprises a circular (e.g., ring) shape, although it should be understood that other shapes (e.g., oval, square, or any other polygonal shape) may be used. When the plant grow ring is installed into the soil, the main body portion generally sits above the surface of the soil and serves to contain water and nutrients within the main body such that they are directed toward the plant, while preventing pests and other external forces (e.g., runoff) from damaging the base of the plant. The plant grow ring may also include a plurality of legs that generally protrude from the bottom of the main body portion. The legs are generally configured to pierce into the soil and protrude some length below the surface of the soil to hold the plant grow ring in place. Additionally, as described in more detail with reference to the figures, the legs may also provide an underground surface area that helps guide the roots downward such that the roots are encouraged to grow deeper into the soil rather than laterally directly under the surface of the soil. However, the shape and size of the legs are designed such that there is some space between adjacent legs such that there is space for a portion of the roots to grow laterally beneath the surface of the soil. In this way, the legs advantageously encourage deeper root growth while allowing some root growth in a lateral direction, thereby facilitating optimal root growth directionality.

The plant grow ring may include one or more features to further enhance the growth, development, and protection of the plant. For example, the plant grow ring may include one or more features to facilitate irrigation connections such that irrigation tubing is easily attached to the plant grow ring. Additionally, the plant grow ring may include ridge-like features on an external surface of the main body portion that are designed to prevent pests from crawling up the surface of the main body portion and into the ring. These ridge-like features may also serve as attachment points for one or more removable accessory features. In one example, a removable accessory includes a tray-like feature that sits atop the plant grow ring and generally supports the bottom portion of the plan such that the plant does not rest directly on the surface of the soil. Such a tray may be suitable for strawberry plants, but may be used in other similar situations. In another example, a conical or dome-shaped greenhouse attachment (e.g., topper) accessory may be removably attached to the ridge-like features. The greenhouse attachment may generally be configured as a protectant feature for seedlings or other delicate plants, and may include holes or similar features to allow limited amounts of light and water to pass through, while generally protecting the seedling from pests (e.g., rodents or other animals) or damaging amounts of rain. Other advantageous features of the plant grow ring are described herein that provide various improvements over existing devices.

The plant grow ring as described herein addresses significant gaps in the current gardening market, particularly in the context of managing fertilizer runoff and ensuring efficient nutrient delivery deep to the roots. For example, traditional makeshift solutions like repurposed nursery pots or cut buckets degrade quickly and are not environmentally sustainable. These makeshift solutions often become brittle and break apart after a few weeks in the garden, contributing to plastic waste. The plant grow ring as described herein is robustly designed and made from recycled material that outlasts these alternatives.

Also, common existing solutions typically come in limited colors like black or brown, which do not contribute to attracting pollinators. The plant grow ring as described herein may be manufactured in a range of vibrant colors, enhancing the visual appeal of gardens and aiding in pollinator attraction.

Furthermore, unlike makeshift rings, the plant grow ring as described here is specifically designed to direct water and nutrients to the root zone, reducing wastage and effectively countering the challenges of hydrophobic soil. Putting a 5-gallon bucket around the base of plants, ˜12″ in diameter wastes a large amount of water and nutrients when used with small plants.

As described herein, the unique ridges on the outer surface of the plant grow ring and optional non-toxic adhesive layers offer superior pest protection compared to traditional garden barriers, reducing the need for chemical pesticides and ensuring healthier plant growth.

The plant grow ring can include a range of alternative designs, including adjustable sizes and the snap-open feature, which makes the plant grow ring adaptable for a wide spectrum of plants, from small herbs to larger trees, making it a versatile tool for gardeners and landscapers.

The plant grow ring includes features for ease of use. Gardeners may simply slip the plant grow ring over young seedlings. Soil amendments like manure or fertilizer are added inside the plant grow ring. By confining fertilizer application, it becomes more focused around the plant's root area. This concentrated approach allows for reduced usage of fertilizer while still delivering the same amount of nutrients to the plants. This method is beneficial both for gardeners and the environment. Watering is done within the plant grow ring, ensuring efficient delivery to the roots. The plant grow ring effectively manages the water and nutrient distribution, significantly reducing runoff and promoting healthy plant growth. Additionally, the plant grow rings can be color-coordinated to match the fruit color, such as red for tomatoes, aiding in plant identification and organization.

Aspects of the disclosure are initially described in the context of plant grow rings and assemblies of plant grow rings with one or more optional accessories.

This description provides examples, and is not intended to limit the scope, applicability or configuration of the principles described herein. Rather, the ensuing description will provide those skilled in the art with an enabling description for implementing various aspects of the principles described herein. As can be understood by one skilled in the art, various changes may be made in the function and arrangement of elements without departing from the application.

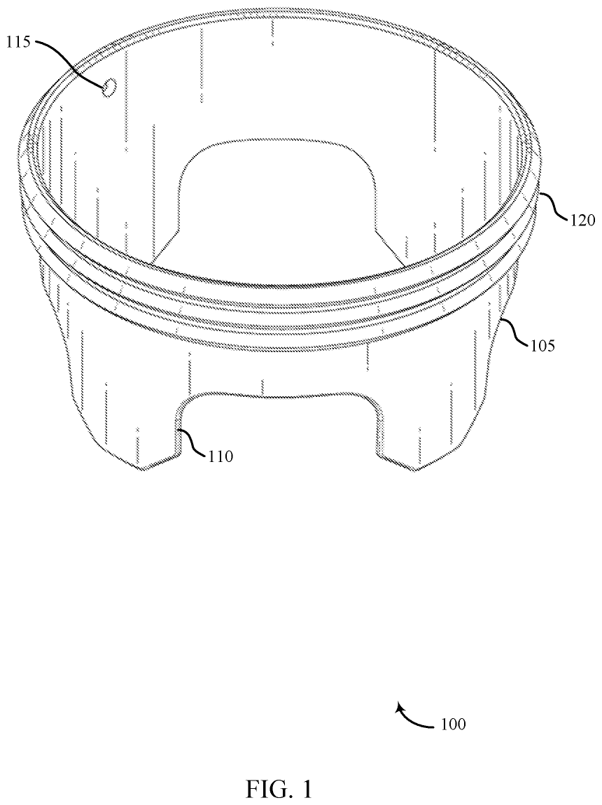

FIG. 1 illustrates a perspective view of an example plant grow ring 100 in accordance with aspects of the present disclosure. The plant grow ring 100 includes a main body 105 that may generally be circular in shape, although other shapes are contemplated herein (e.g., oval, polygonal, etc.). The main body 105 is generally configured to sit atop the soil when the plant grow ring 100 is installed into the soil. As such, the main body 105 generally provides for an internal surface area that helps contain water at or near the base of the plant, prevent soil and nutrient runoff, and/or provide structural support to the plant itself. As such, the main body 105 helps ensure that water and nutrients seep downwards, directly reaching the plant's roots for optimal absorption. Stopping fertilizer runoff is also a significant benefit of the main body 105, as fertilizer runoff leads to downstream pollution and creates favorable condition for growth of phenomena such as algae bloom. The physical barrier of the main body 105 may also be effective in containing the spread of invasive herbs like mint, maintaining organized garden spaces. Furthermore, plant grow ring 100 may be manufactured in a variety of vibrant colors (e.g., red, yellow, orange, purple, etc.), so that the plant grow ring 100 not only adds visual appeal to gardens, organizes plant type by color, but also assists in organizing different plant types and attracting pollinators. In one example, the main body 105 is approximately 7 inches in diameter.

The plant grow ring 100 may also include a plurality of legs 110 that protrude from a bottom of the main body 105. The legs 110 are configured to protrude into the surface of the soil to secure the plant grow ring 100 in place. The legs 110 are also advantageously designed to promote healthy root growth directionality. For example, the legs 110 may generally contour along a same circumferential inner surface as the main body 105. As such, the legs 110 may provide an underground surface area that serves as a physical barrier, similar to how the main body 105 serves as a physical barrier above the surface of the soil. The legs 110 therefore are designed to have a width that provides some underground barrier to block all of the roots from growing laterally (e.g., generally parallel with the soil surface) directly under the soil surface. Instead, the surface area created by the legs 110 may block some lateral growth and encourage some of the roots to travel deeper into the soil than they would have otherwise. As such, the roots will travel deeper into the soil and will have access to more soil depths and nutrient profiles, thereby maximizing absorption of nutrients found at various depths and layers of the soil. However, it was recognized that creating a totally circumferential underground barrier would prevent all lateral root development directly under the soil. As such, the legs 110 are spaced apart from each other to allow for some interstitial space that allows for some lateral root growth in between the legs 110 under the surface of the soil. The shape and size of the legs 110 therefore provide for an optimal mix of deep-root stimulation and shallow root growth, thereby providing the plant an optimal variety of root depths. The plant grow ring 100 may include 4 legs 110. However, it is to be understood that additional or fewer legs 110 may be used in accordance with aspects of the present disclosure. In such alternative examples, the relative width and/or depth of the legs 110 may be adjusted relative to what is shown in FIG. 1 to provide the described balance between deep root growth stimulation and lateral root growth flexibility.

In an example, the height of the plant grow ring 100, including the legs 110, is approximately 4 inches. The plant grow ring 100 may be constructed from 100% recycled ultraviolet (UV) stabilized copolymer polypropylene plastic. The plan grow ring 100 may be produced through injection molding, ensuring durability and environmental sustainability.

In an example, the plant grow ring 100 may include one or more features to facilitate irrigation of the plant. For example, the plant grow ring 100 may include a hole 115 positioned within the side of the main body 105 (e.g., a ¼″ hole) that is configured for attaching a drip irrigation line or tube. The use of a hole 115 that is elevated with respect to the soil surface advantageously allows the mounting of drip lines to prevent clogging, a common problem from drip lines or soaker lines that simply lay on the soil surface. The hole 115 allows for the plant grow ring 100 to be used in lieu of a separate drip line mounting stake, further saving money.

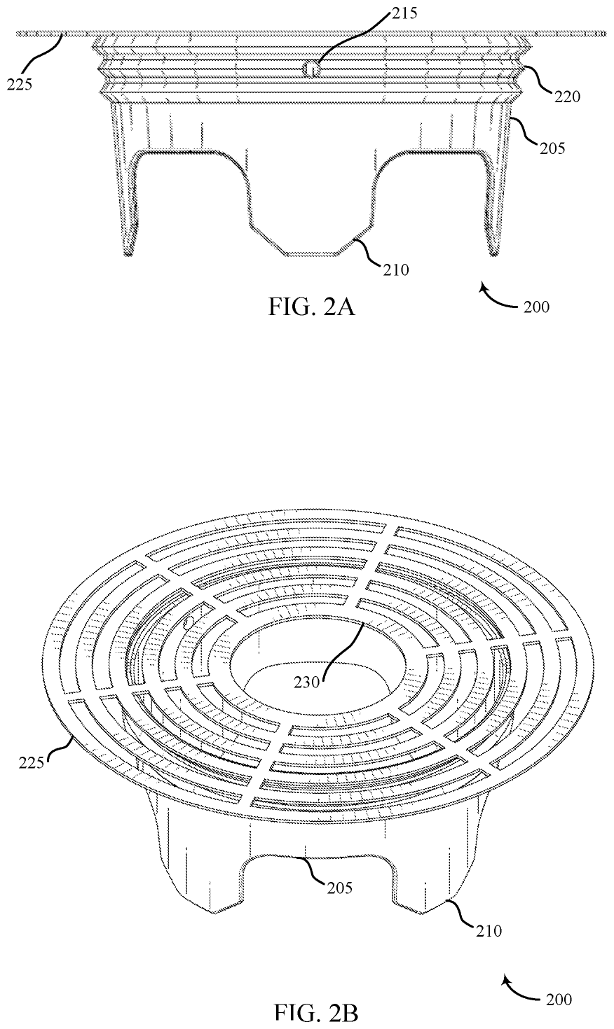

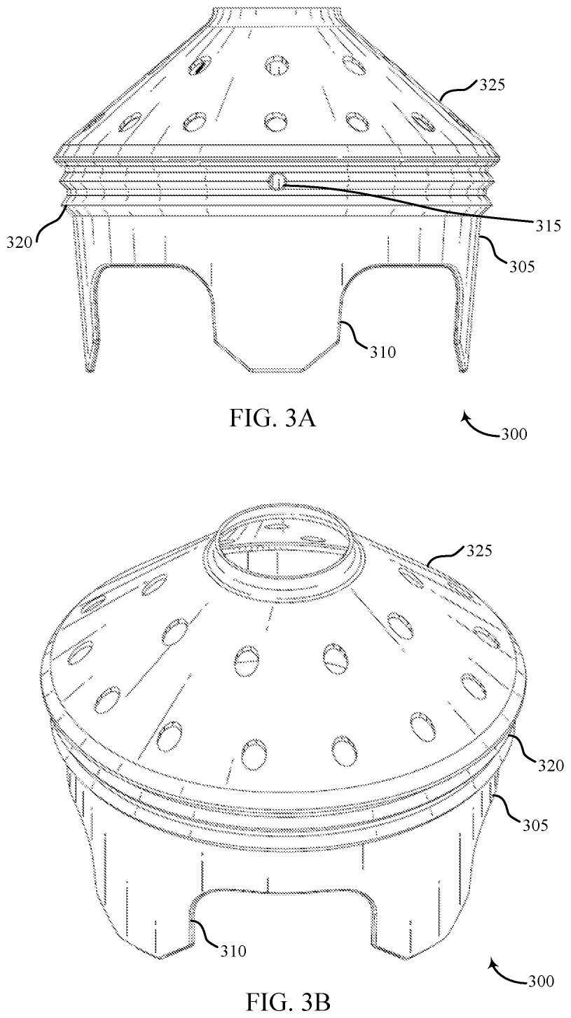

The plant grow ring 100 may include one or more features designed to deter pest (e.g., crawling pests) from getting to the plant contained within the plant grow ring 100. For example, the outer surface of the plant grow ring 100 may include one or more protrusions or ridges 120. These ridges 120 act as a physical barrier to prevent pests from crawling up the outside surface of the plant grow ring 100. In some examples, there may be 3 ridges 120 (as shown in FIG. 1), but additional or fewer ridges 120 may also be used. One or more of the ridges 120 may also serve as an attachment point for one or more removable accessories, as described in more detail with respect to FIGS. 2-3. As such, the ridges 120 may provide two simultaneous functions.

FIG. 2A illustrates a side view of a plant grow ring 200 in accordance with aspects of the present disclosure. The plant grow ring 200 may include a main body 205, a plurality of legs 210, an irrigation hole 215, and a plurality of ridges 220, which may be examples of the corresponding features described with reference to FIG. 1. The plant grow ring 200 may also include an innovative tray attachment 225 that is removably coupled to the main body 205 via one or more of the ridges 220. For example, the bottom of the tray attachment 225 may include a concave curved portion that is sized to mate with the convex portion of the top ridge 220, such that when the tray attachment 225 is pushed downward onto the main body 205, the tray attachment 225 will snap onto one or more of the ridges 220. As such, there are no additional tools or parts needed to attach the tray attachment 225 to the plant grow ring 200, and instead, the ridges 220 that are configured to deter pests may also serve as the attachment mechanism for the tray attachment 225. Designed to support fruit-bearing plants such as strawberries, the tray attachment 225 elevates the fruit above the soil, reducing the risk of rot and pest infestation. The tray attachment 225 is detachable by simply pulling the tray attachment 225 from the main body 205 until the tray attachment 225 unsnaps from the ridges 220, allowing for easy cleaning and seasonal adjustments. Its design ensures that the fruits are well-aerated and accessible for harvesting, while also protecting them from soil-borne diseases. For plants like strawberries, the tray attachment 225 offers a simple yet effective solution. For example, the plant grow ring 200 may be placed over the strawberry plant, allowing the fruits to rest on the tray attachment 225. This setup prevents fruit contact with the soil, reducing rot and pest infestation. The tray attachment 225 also makes harvesting easier. The color-coding feature of the rings (e.g., plant grow rings used for strawberries may be colored red) can further assist in identifying different fruit plants in a garden.

FIG. 2B illustrates a perspective view of the plant grow ring 200 in accordance with aspects of the present disclosure, so that the features of the tray attachment 225 can be more easily shown. As illustrated, the tray attachment 225 may include a plurality of slots in its surface to facilitate air flow to the plant or fruit that is resting on the surface. Also as shown, the tray attachment 225 includes a hole 230 in its center to allow the plant to grow up through the tray and at least partially rest on the surface of the tray. The diameter of the hole 230 may be smaller than the inner diameter of the main body 205. The smaller diameter of the hole 230 may help bunch the stalk and bottom portion of the plant together (thereby preventing it from resting on the ground within the main body 205) and encouraging the plant to grow more vertically and to ultimately at least partially rest on a top surface of the tray attachment 225.

FIG. 3A illustrates a side view of a plant grow ring 300 in accordance with aspects of the present disclosure. The plant grow ring 300 may include a main body 305, a plurality of legs 310, an irrigation hole 315, and a plurality of ridges 320, which may be examples of the corresponding features described with reference to FIG. 1 and FIG. 2. The plant grow ring 300 may also include dome-shaped greenhouse attachment 325. The greenhouse attachment 325 may be manufactured from durable, translucent plastic and may include strategically placed holes for optimal air and water flow, while preventing entry of small rodents and other pests. This greenhouse attachment 325 is particularly beneficial for seedlings, creating a microclimate that accelerates growth by trapping warmth and protecting from adverse weather. The greenhouse attachment 325 is designed for easy installation and removal, catering to the needs of gardeners who require flexibility in plant protection. True organic gardening requires starting plants from seed and not seedlings. Growing from seed directly outside is challenging due to many pests that can damage young seedlings. The greenhouse attachment 325 accessory enables gardeners to successfully grow plants from seeds directly on the ground. The greenhouse attachment 325 may help warm the soil faster in the spring and protect young plants from late spring freezes, effectively lengthening the growing season. Similar to the tray attachment 225 described with reference to FIG. 2, the greenhouse attachment 325 may snap onto one or more of the ridges 320, and may be removed by unsnapping from the one or more ridges 320. As such, the grow ring 300 is configured to facilitate flexible configurations of multiple accessories without having to use additional hardware or tools.

FIG. 3B illustrates a perspective view of the plant grow ring 300 in accordance with aspects of the present disclosure, so that the features of the greenhouse attachment 325 can be more easily shown.

In some examples, any of the plant grow rings 100, 200, or 300 may be adapted for larger plants, including bushes and trees. Such alternative examples may include significantly enlarged diameter and additional side holes to cater to the extensive watering requirements of these plants. The increased size ensures that the root systems of larger plants receive adequate water and nutrients. This alternatively example is ideal for landscapers and gardeners who work with a variety of plant sizes and require a solution that can accommodate the diverse needs of a garden or orchard.

Additionally or alternatively, any of the plant grow rings 100, 200, or 300 may be manufactured in an array of colors and textures, offering both functional and aesthetic benefits. Colored rings can be used for thematic gardening, special events, or awareness campaigns. Textures such as wood grain or stone-like finishes add an artistic touch to the garden, blending seamlessly with natural surroundings. These variations provide gardeners with the opportunity to personalize their space while maintaining the functional benefits of the plant grow rings 100, 200, and 300, as described herein.

Additionally or alternatively, any of the plant grow rings 100, 200, or 300 may include a snap-open mechanism that allows the main body to open and then be snaped close, allowing the plan grow ring to be easily installed around mature or larger plants. This design addresses the challenge of adding soil and root support to established plants without disturbing their growth. The snap feature is robust yet easy to operate, ensuring that the plant grow ring can be securely closed around the plant. This example is particularly useful for gardeners who wish to add the plant grow ring to their existing garden setup without the need for replanting or significant soil disturbance.

In some examples the plant grow ring 100, 200, or 300 is constructed from non-petroleum-based biodegradable materials. This eco-friendly version caters to environmentally conscious consumers, offering a gardening solution that minimizes environmental impact. The biodegradable plant grow ring is designed to maintain its structural integrity and functionality for a significant duration before naturally decomposing, leaving no harmful residues in the soil. This embodiment represents a commitment to sustainable gardening practices, aligning with the growing global emphasis on eco-friendly products.

Additionally or alternatively, any of the plant grow rings 100, 200, or 300 may include an innovative addition to its pest deterrent capabilities. The outer ridges of the plant grow ring may be coated with a layer of non-toxic, tacky adhesive. This sticky substance acts as an additional barrier, effectively preventing pests like slugs and insects from climbing over and reaching the plant. The adhesive is formulated to be durable and weather-resistant, ensuring long-lasting protection without the need for frequent reapplications. This Example provides an extra layer of defense, enhancing the plant grow ring's utility in maintaining healthy and pest-free plant growth.

The description set forth herein, in connection with the appended drawings, describes example configurations and does not represent all the examples that may be implemented or that are within the scope of the claims. The detailed description includes specific details for the purpose of providing an understanding of the described techniques. These techniques, however, may be practiced without these specific details.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A plant grow ring, comprising:
a cylindrical main body having an inner surface, an exterior surface, a top surface, and a bottom surface;
a plurality of legs protruding from the bottom surface of the cylindrical main body, wherein each leg of the plurality of legs comprises a width and a height, and wherein each leg of the plurality of legs is curved across the width to match a curvature of the inner surface of the cylindrical main body; and
a plurality of ridges formed on the exterior surface of the cylindrical main body and adjacent to the top surface of the cylindrical main body, wherein at least a top ridge of the plurality of ridges are configured to releasably couple with a corresponding mating feature of one or more accessories that are attachable to the top surface of the cylindrical main body.

2. The plant grow ring of claim 1, further comprising:
a hole disposed through the cylindrical main body and configured to releasably couple with an irrigation tube.

3. The plant grow ring of claim 2, wherein the hole is located among the plurality or ridges.

4. The plant grow ring of claim 1, wherein the one or more accessories comprises a tray attachment configured to releasably couple with at least the top ridge of the plurality of ridges by snapping onto the at least top ridge.

5. The plant grow ring of claim 4, wherein the tray attachment comprises an annulus portion having an exterior circumference, an inner circumference, and a plurality of slits formed through a thickness of the annulus portion, wherein a diameter of the inner circumference is less than a diameter of the inner surface of the cylindrical main body, and wherein a diameter of the exterior circumference is greater than a diameter of the exterior surface of the cylindrical main body.

6. The plant grow ring of claim 1, wherein the one or more accessories comprises a greenhouse attachment configured to releasably couple with at least the top ridge of the plurality of ridges by snapping onto the at least top ridge.

7. The plant grow ring of claim 6, wherein the greenhouse attachment comprises a domed surface made from an at least partially translucent material and a plurality of holes formed through a thickness of the domed surface.

8. The plant grow ring of claim 1, further comprising:
an adhesive layer formed over at least the plurality of ridges.

9. The plant grow ring of claim 1, wherein at least the cylindrical main body and the plurality of legs are formed from an ultraviolet stabilized copolymer polypropylene plastic material that is formed via an injection molding process.

10. The plant grow ring of claim 1, wherein at least the cylindrical main body and the plurality of legs are formed from a biodegradable material.

11. The plant grow ring of claim 1, wherein the cylindrical main body comprises a slit running along a full height of the cylindrical main body such that the cylindrical main body is openable, wherein the cylindrical main body further comprises a latching features the secures the cylindrical main body in a closed position.
